(19) United States
(12) Patent Application Publication
(10) Pub. No.: US 2026/0244771 A1
(43) Pub. Date: Aug. 20, 2026

(54) SECURE DATA STORAGE SYSTEMS AND METHODS FOR VEHICLES

(71) Applicant: GM Global Technology Operations LLC, Detroit, MI (US)

(72) Inventors: Kenneth Junk, Marshalltown, IA (US); Brian Farrell, Troy, MI (US); Manohar Reddy Nanjundappa, Round Rock, TX (US)

(21) Appl. No.: 19/055,972

(22) Filed: Feb. 18, 2025

(51) Int. Cl. G06F 21/60; G06F 21/64; H04L 9/08; H04L 9/32

(52) U.S. Cl. CPC G06F 21/606; G06F 21/64; H04L 9/0863; H04L 9/3271

(57) ABSTRACT

A method for provisioning a data storage device (DSD) using a security management controller (SMC) may include determining an operational mode of the DSD. The operational mode includes one of: a factory mode and a non-factory mode. The method further may include configuring an attestation passkey on the DSD based at least in part on the operational mode of the DSD. The attestation passkey is used to unlock communication between the DSD and one or more external devices. The method further may include configuring a credential pin (C_PIN) on the DSD based at least in part on the operational mode of the DSD. The C_PIN is used to encrypt and decrypt data stored on the DSD.

### INTRODUCTION

The present disclosure relates to systems and methods for secure data storage, and more particularly, to systems for secure data storage for vehicle controllers and methods for provisioning and configuring systems for secure data storage for vehicle controllers.

To manage computational tasks in vehicle applications, vehicle controllers may be utilized. Vehicle controllers may include processors, memory units, and input/output interfaces configured to execute tasks such as, for example, real-time control, data acquisition, data processing, and/or the like. In some examples, vehicle controllers are configured with embedded storage solutions, allowing for data retention and retrieval in real-time applications. The data storage may include non-volatile memory systems, enabling the preservation of critical data during power interruptions. Some implementations may integrate artificial intelligence and/or machine learning algorithms to optimize vehicle operations by analyzing data from sensors. In some examples, multiple vehicle controllers are used in tandem to enable coordinated control of multiple vehicle subsystems. In other examples, one or more centralized vehicle controllers control multiple vehicle subsystems with software-defined modules.

While systems and methods for secure data storage achieve their intended purpose, there is a need for new and improved systems and methods for secure data storage for vehicle controllers.

### SUMMARY

According to several aspects, a method for provisioning a data storage device (DSD) using a security management controller (SMC) is provided. The method may include determining an operational mode of the DSD. The operational mode includes one of: a factory mode and a non-factory mode. The method further may include configuring an attestation passkey on the DSD based at least in part on the operational mode of the DSD. The attestation passkey is used to unlock communication between the DSD and one or more external devices. The method further may include configuring a credential pin (C_PIN) on the DSD based at least in part on the operational mode of the DSD. The C_PIN is used for access control on the DSD.

In another aspect of the present disclosure, configuring the attestation passkey further may include generating a new attestation passkey based at least in part on the operational mode of the DSD. Configuring the attestation passkey further may include transmitting the new attestation passkey to the DSD based at least in part on the operational mode of the DSD. Configuring the attestation passkey further may include writing the new attestation passkey to a non-volatile memory (NVM) of the DSD. Configuring the attestation passkey further may include verifying an integrity of the new attestation passkey stored in the NVM.

In another aspect of the present disclosure, generating the new attestation passkey further may include generating the new attestation passkey using a remote server system in response to determining that the operational mode is the non-factory mode. Generating the new attestation passkey further may include generating the new attestation passkey using the SMC in response to determining that the operational mode is the factory mode.

In another aspect of the present disclosure, transmitting the new attestation passkey to the DSD further may include generating an encrypted new attestation passkey by encrypting the new attestation passkey with a key encryption key (KEK) using a remote server system in response to determining that the operational mode is the non-factory mode. The KEK is generated based at least in part on a nonce generated by the DSD. Transmitting the new attestation passkey to the DSD further may include transmitting the encrypted new attestation passkey to the DSD with an attestation passkey transport message authentication code (MAC) for integrity verification in response to determining that the operational mode is the non-factory mode. Transmitting the new attestation passkey to the DSD further may include transmitting the new attestation passkey in plaintext to the DSD with the attestation passkey transport MAC for integrity verification in response to determining that the operational mode is the factory mode.

In another aspect of the present disclosure, writing the new attestation passkey to the NVM further may include verifying an integrity of the new attestation passkey in plaintext or the encrypted new attestation passkey using the attestation passkey transport MAC. Writing the new attestation passkey to the NVM further may include writing the new attestation passkey to the NVM in response to determine that the new attestation passkey in plaintext or the encrypted new attestation passkey is intact.

In another aspect of the present disclosure, verifying the integrity of the new attestation passkey stored in the NVM further may include deriving a NVM programming message authentication code (MAC) key using the DSD based at least in part on the new attestation passkey stored in the NVM and a programming nonce. Verifying the integrity of the new attestation passkey stored in the NVM further may include calculating an NVM programming MAC of a known test vector using the DSD. Verifying the integrity of the new attestation passkey stored in the NVM further may include transmitting the NVM programming MAC and the programming nonce to the SMC. Verifying the integrity of the new attestation passkey stored in the NVM further may include calculating an SMC programming MAC key based on the programming nonce and the new attestation passkey. Verifying the integrity of the new attestation passkey stored in the NVM further may include calculating an SMC programming MAC of the known test vector using the SMC. Verifying the integrity of the new attestation passkey stored in the NVM further may include verifying the integrity of the new attestation passkey stored in the NVM by comparing the SMC programming MAC to the NVM programming MAC.

In another aspect of the present disclosure, configuring the C_PIN further may include generating a new C_PIN. Configuring the C_PIN further may include transmitting the new C_PIN to the DSD based at least in part on the operational mode of the DSD. Configuring the C_PIN further may include storing the new C_PIN in the DSD. Configuring the C_PIN further may include verifying an integrity of the new C_PIN stored in the DSD.

In another aspect of the present disclosure, transmitting the new C_PIN to the DSD further may include transmitting an encrypted new C_PIN to the DSD with a C_PIN transport MAC for integrity verification in response to determining that the operational mode is the non-factory mode. Transmitting the new C_PIN to the DSD further may include transmitting the new C_PIN in plaintext to the DSD with a C_PIN transport MAC for integrity verification in response to determining that the operational mode is the factory mode.

In another aspect of the present disclosure, transmitting the new C_PIN to the DSD further may include retrieving a C_PIN nonce from the DSD. Transmitting the new C_PIN to the DSD further may include generating a C_PIN key encryption key (KEK) using the SMC based on the C_PIN nonce in response to determining that the operational mode is the non-factory mode. Transmitting the new C_PIN to the DSD further may include generating a C_PIN transport message authentication code (MAC) key using the SMC based on the C_PIN nonce. Transmitting the new C_PIN to the DSD further may include generating an encrypted new C_PIN by encrypting the new C_PIN with the C_PIN KEK in response to determining that the operational mode is the non-factory mode. Transmitting the new C_PIN to the DSD further may include generating a C_PIN transport MAC using the C_PIN transport MAC key. Transmitting the new C_PIN to the DSD further may include transmitting the encrypted new C_PIN to the DSD with the C_PIN transport MAC for integrity verification in response to determining that the operational mode is the non-factory mode. Transmitting the new C_PIN to the DSD further may include transmitting the new C_PIN in plaintext to the DSD with the C_PIN transport MAC for integrity verification in response to determining that the operational mode is the factory mode.

In another aspect of the present disclosure, storing the new C_PIN in the DSD further may include verifying an integrity of the new C_PIN in plaintext or the encrypted new C_PIN received from the SMC using the C_PIN transport MAC. Storing the new C_PIN in the DSD further may include calculating the C_PIN KEK using the DSD in response to determining that the operational mode is the non-factory mode. Storing the new C_PIN in the DSD further may include determining the new C_PIN in plaintext by decrypting the encrypted new C_PIN using the C_PIN KEK in response to determining that the operational mode is the non-factory mode. Storing the new C_PIN in the DSD further may include securely storing the new C_PIN in the DSD.

According to several aspects, a system for secure data storage is provided. The system may include a security management controller (SMC) and a data storage device (DSD) in electrical communication with the SMC. The DSD includes a DSD controller and one or more ports for electrical communication with external devices. The DSD controller is programmed to determine an operational mode of the DSD. The operational mode includes one of: a factory mode and a non-factory mode. The DSD controller is further programmed to start the DSD in a lockdown mode in response to determining that the operational mode is the non-factory mode. In the lockdown mode, the DSD is configured to ignore all commands received by the DSD besides a predetermined list of allowed commands. In the lockdown mode, the DSD is further configured to restrict the one or more ports. The DSD controller is further programmed to start the DSD in an non-lockdown mode in response to determining that the operational mode is the factory mode. The SMC is programmed to authenticate the DSD in response to determining that the operational mode is the non-factory mode. The SMC is further programmed to unrestrict one or more of the one or more ports in response to authenticating the DSD.

In another aspect of the present disclosure, to authenticate the DSD, the SMC is further programmed to generate a random challenge. To authenticate the DSD, the SMC is further programmed to calculate a correct challenge response to the random challenge based at least in part on the random challenge and an attestation passkey. To authenticate the DSD, the SMC is further programmed to transmit the random challenge to the DSD controller using at least one of the allowed commands. To authenticate the DSD, the SMC is further programmed to read a challenge response from the DSD controller using at least one of the allowed commands. To authenticate the DSD, the SMC is further programmed to authenticate the DSD in response to determining that the challenge response matches the correct challenge response.

In another aspect of the present disclosure, the SMC is further programmed to update the attestation passkey on the DSD. To update the attestation passkey on the DSD, the SMC is further programmed to generate a new attestation passkey based at least in part on the operational mode of the DSD. To update the attestation passkey on the DSD, the SMC is further programmed to transmit the new attestation passkey to the DSD controller based at least in part on the operational mode of the DSD. To update the attestation passkey on the DSD, the SMC is further programmed to write the new attestation passkey to a non-volatile memory (NVM) of the DSD. To update the attestation passkey on the DSD, the SMC is further programmed to verify an integrity of the new attestation passkey stored in the NVM.

In another aspect of the present disclosure, to generate the new attestation passkey, the SMC is further programmed to retrieve the new attestation passkey from a remote server system in response to determining that the operational mode is the non-factory mode. The new attestation passkey is generated by the remote server system based at least in part on a unique identification number of the DSD and a nonce generated by the data storage device. To generate the new attestation passkey, the SMC is further programmed to generate the new attestation passkey using the SMC in response to determining that the operational mode is the factory mode.

In another aspect of the present disclosure, to transmit the new attestation passkey to the DSD, the SMC is further programmed to generate an encrypted new attestation passkey by encrypting the new attestation passkey with a key encryption key (KEK) using the remote server system in response to determining that the operational mode is the non-factory mode. To transmit the new attestation passkey to the DSD, the SMC is further programmed to transmit the encrypted new attestation passkey to the DSD with an attestation passkey transport message authentication code (MAC) for integrity verification in response to determining that the operational mode is the non-factory mode. To transmit the new attestation passkey to the DSD, the SMC is further programmed to transmit the new attestation passkey in plaintext to the DSD with the attestation passkey transport MAC for integrity verification in response to determining that the operational mode is the factory mode.

In another aspect of the present disclosure, to verify the integrity of the new attestation passkey stored in the NVM, the SMC is further programmed to receive an NVM programming message authentication code (MAC) and a programming nonce from the DSD. The NVM programming MAC is calculated by the DSD controller based at least in part on the new attestation passkey stored in the NVM and the programming nonce. To verify the integrity of the new attestation passkey stored in the NVM, the SMC is further programmed to calculate an SMC programming MAC based at least in part on based on the programming nonce and the new attestation passkey. To verify the integrity of the new attestation passkey stored in the NVM, the SMC is further programmed to verify the integrity of the new attestation passkey stored in the NVM by comparing the SMC programming MAC to the NVM programming MAC.

In another aspect of the present disclosure, the SMC is further programmed to update a credential pin (C_PIN) on the DSD. To update the C_PIN on the DSD, the SMC is further programmed to generate a new C_PIN. To update the C_PIN on the DSD, the SMC is further programmed to transmit an encrypted new C_PIN to the DSD with a C_PIN transport MAC for integrity verification in response to determining that the operational mode is the non-factory mode. To update the C_PIN on the DSD, the SMC is further programmed to transmit the new C_PIN in plaintext to the DSD with a C_PIN transport MAC for integrity verification in response to determining that the operational mode is the factory mode. To update the C_PIN on the DSD, the SMC is further programmed to store the new C_PIN in the DSD. To update the C_PIN on the DSD, the SMC is further programmed to verify an integrity of the new C_PIN stored in the DSD.

According to several aspects, a system for secure data storage for a vehicle controller is provided. The system may include a vehicle controller including a solid-state drive (SSD). The SSD includes a flash memory controller and one or more ports for electrical communication with external devices. The vehicle controller further may include a security management controller (SMC) in electrical communication with the SSD. The SMC is programmed to determine an operational mode of the SSD. The operational mode includes one of: a factory mode and a non-factory mode. The SMC is programmed to authenticate the SSD using an attestation passkey in response to determining that the operational mode is the non-factory mode. The SMC is programmed to unrestrict one or more of the one or more ports in response to authenticating the SSD.

In another aspect of the present disclosure, the SMC is further programmed to update the attestation passkey on the SSD. To update the attestation passkey on the SSD, the SMC is further programmed to generate a new attestation passkey based at least in part on the operational mode of the SSD. To update the attestation passkey on the SSD, the SMC is further programmed to transmit the new attestation passkey to the flash memory controller based at least in part on the operational mode of the SSD. The new attestation passkey is encrypted before transmission in response to determining that the operational mode is the non-factory mode. To update the attestation passkey on the SSD, the SMC is further programmed to write the new attestation passkey to a non-volatile memory (NVM) of the SSD. To update the attestation passkey on the SSD, the SMC is further programmed to verify an integrity of the new attestation passkey stored in the NVM.

In another aspect of the present disclosure, the SMC is further programmed to update a credential pin (C_PIN) on the SSD. The C_PIN is used for access control on the SSD. To update the C_PIN on the SSD, the SMC is further programmed to generate a new C_PIN. To update the C_PIN on the SSD, the SMC is further programmed to transmit an encrypted new C_PIN to the SSD with a C_PIN transport MAC for integrity verification in response to determining that the operational mode is the non-factory mode. To update the C_PIN on the SSD, the SMC is further programmed to transmit the new C_PIN in plaintext to the SSD with a C_PIN transport MAC for integrity verification in response to determining that the operational mode is the factory mode. To update the C_PIN on the SSD, the SMC is further programmed to store the new C_PIN in the SSD. To update the C_PIN on the SSD, the SMC is further programmed to verify an integrity of the new C_PIN stored in the SSD.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for secure data storage for a vehicle, according to an exemplary embodiment;

FIG. 2 is a flowchart of a method for configuring or updating an attestation passkey on a data storage device, according to an exemplary embodiment;

FIG. 3 is a continuation of the flowchart of FIG. 2 of the method for configuring or updating the attestation passkey on the data storage device, according to an exemplary embodiment;

FIG. 4 is a flowchart of a method for configuring or updating a credential pin on the data storage device, according to an exemplary embodiment; and

FIG. 5 is a flowchart of a method for operating the system for secure data storage for a vehicle, according to an exemplary embodiment.

### DETAILED DESCRIPTION

The following description is merely exemplary in nature and is not intended to limit the present disclosure, application, or uses.

In aspects of the present disclosure, to increase occupant comfort and vehicle performance, vehicle systems may gather and store data related to vehicle operation, such as, for example, data gathered by vehicle sensors. In aspects of the present disclosure, it is advantageous to prevent unauthorized access to stored data, particularly in cases where the data storage devices are removable such that communication interfaces (e.g., serial links) may be exposed. Furthermore, it is advantageous to protect vehicle systems from influence by unauthorized connected devices or peripherals. Accordingly, the present disclosure provides new and improved systems and methods for secure data storage, device authentication, and device configuration for vehicles.

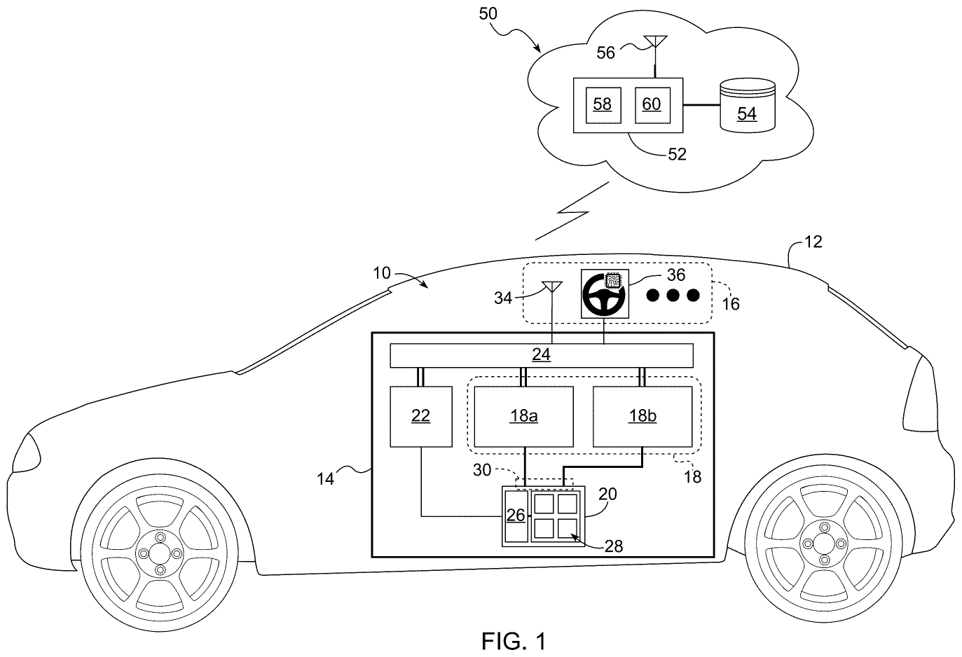

Referring to FIG. 1, a system for secure data storage for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a vehicle controller 14 and a plurality of vehicle components 16.

The vehicle controller 14 is used to implement method 100, method 200, and method 300, as will be described below. The vehicle controller 14 includes one or more processors or compute units and a non-transitory computer readable storage device or media. The one or more processors or compute units may include custom made or commercially available processors or computing units, central processing units (CPUs), graphics processing units (GPUs), semiconductor-based microprocessors (in the form of microchips or chip sets), field-programmable gate arrays (FPGAs), a combination thereof, or generally a device for executing instructions.

The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the one or more processors or compute units is powered down. The computer-readable storage device or media may be implemented using a number of memory devices such as PROMs (programmable read-only memory), EPROMs (electrically PROM), EEPROMs (electrically erasable PROM), flash memory, universal flash storage (UFS), or another electric, magnetic, optical, or combination memory devices capable of storing data, some of which represent executable instructions, used by the vehicle controller 14 to control various systems of the vehicle 12.

The vehicle controller 14 may also include multiple controllers which are in electrical communication with each other. The vehicle controller 14 may be inter-connected with additional systems and/or controllers of the vehicle 12, allowing the vehicle controller 14 to access data such as, for example, speed, acceleration, braking, and steering angle of the vehicle 12.

The vehicle controller 14 is in electrical communication with the plurality of vehicle components 16. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the vehicle controller 14 are within the scope of the present disclosure. It should further be understood that, in the scope of the present disclosure, electrical communication also includes power and/or energy transfer between electrical devices (e.g., using conducting wires and/or wireless power transmission techniques).

In an exemplary embodiment, the one or more processors or compute units of the vehicle controller 14 are realized by one or more compute modules 18. The computer readable storage device or media is realized by a data storage device (DSD) 20. The vehicle controller 14 further includes a security management controller (SMC) 22 and an external interface 24.

The one or more compute modules 18 may include general-purpose processors (e.g., microcontrollers) and/or application specific processors (e.g., application specific integrated circuits (ASICs), graphics processing units (GPUs), and/or the like). In a non-limiting example, the one or more compute modules 18 include a first compute module 18a and a second compute module 18b. In a non-limiting example, the first compute module 18a is a general-purpose processor for control of vehicle functions. In a non-limiting example, the second compute module 18b is an application specific processor (e.g., a GPU for execution of machine learning algorithms). While two compute modules are shown and discussed, it should be understood that the one or more compute modules 18 may include any number of compute modules.

The data storage device (DSD) 20 is used to store data, program instructions, runtime variables, and/or the like. In an exemplary embodiment, the DSD 20 includes a DSD controller 26, a data storage medium 28, and one or more ports 30. In a non-limiting example, the DSD controller 26 is used to control features and capabilities of the DSD 20 such as, for example, activation/deactivation of any of the one or more ports 30, encryption of data stored on the data storage medium 28, and/or the like. The DSD controller 26 may include one or more processors (e.g., microprocessors) and a non-transitory media (e.g., non-volatile memory (NVM)) for storing program instructions, runtime variables, and/or data.

The one or more ports 30 are used for electrical communication with external devices (i.e., devices external to the DSD 20, e.g., the one or more compute modules 18). The one or more ports 30 may be realized with any physical or wireless connection and may utilize any digital or analog communication protocol for data transfer. In a non-limiting example, the communication between the one or more ports 30 and the one or more compute modules 18 is established using the peripheral component interconnect express (PCIe) protocol. The DSD controller 26 is also in electrical communication with the SMC 22 for provisioning, configuration, and security management via a separate communication port. In a non-limiting example, the communication between the DSD controller 26 and the SMC 22 is established using the system management bus (SMBus) protocol.

In an exemplary embodiment, the DSD 20 is a solid-state drive (SSD), the DSD controller 26 is a flash memory controller, the data storage medium 28 includes flash storage devices (e.g., NAND flash), and the one or more ports 30 are peripheral component interconnect express (PCIe) ports. It should be understood that the DSD 20 may also be realized with other types of data storage devices, including, for example, electro-mechanical data storage devices and/or additional types of solid-state or flash data storage devices without departing from the scope of the present disclosure.

The security management controller (SMC) 22 is used to manage security and authentication of the DSD 20 to ensure that the DSD 20 is legitimate. In an exemplary embodiment, the SMC 22 includes a processor (e.g., a microprocessor) and a non-transitory media for storage of program instructions, runtime variables, and/or data. The SMC 22 communicates with the DSD 20 using predefined messages (also referred to as commands) recognized by the DSD controller 26. The SMC 22 performs tasks such as authentication of the DSD 20 and configuration/provisioning of security and cryptographic functions and features of the DSD 20, as will be discussed in greater detail below. In a non-limiting example, the SMC 22 is in electrical communication with the DSD 20 via a communication protocol such as, for example, system management bus (SMBus). In another exemplary embodiment, the SMC 22 is realized as one of the one or more compute modules 18 or as a software module running on one of the one or more compute modules 18. The SMC 22 is also in electrical communication with the external interface 24 as will be discussed in greater detail below.

The external interface 24 is used to provide communication between the vehicle controller 14 and devices external to the vehicle controller 14 (e.g., the plurality of vehicle components 16). In an exemplary embodiment, the external interface 24 is a switch and/or router which is in electrical communication with the one or more compute modules 18 and the SMC 22. In a non-limiting example, the external interface 24 is an ethernet switch and/or router and the one or more compute modules 18 and the SMC 22 are in electrical communication with the external interface 24 via ethernet. It should be understood that various additional types of interface devices and protocols are within the scope of the present disclosure.

The plurality of vehicle components 16 are used to provide various features and functions of the vehicle 12. In an exemplary embodiment, the plurality of vehicle components 16 includes at least a vehicle communication system 34 for communication with devices external to the vehicle 12. In a non-limiting example, the plurality of vehicle components 16 further includes an automated driving system 36. It should be understood that the plurality of vehicle components 16 may include any number of additional electrical and/or electro-mechanical systems of the vehicle 12 without departing from the scope of the present disclosure. The plurality of vehicle components 16 are in electrical communication with the vehicle controller 14 via the external interface 24.

The vehicle communication system 34 is used by the vehicle controller 14 to communicate with other systems external to the vehicle 12. For example, the vehicle communication system 34 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems).

In certain embodiments, the vehicle communication system 34 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 34 may further include an embedded universal integrated circuit card (eUICC) configured to store at least one cellular connectivity configuration profile, for example, an embedded subscriber identity module (eSIM) profile.

The vehicle communication system 34 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 34 may include one or more antennas and/or communication transceivers for receiving and/or transmitting signals, such as cooperative sensing messages (CSMs). The vehicle communication system 34 is configured to wirelessly communicate information between the vehicle 12 and another vehicle. Further, the vehicle communication system 34 is configured to wirelessly communicate information between the vehicle 12 and infrastructure or other vehicles. It should be understood that the vehicle communication system 34 may be integrated with the vehicle controller 14 (e.g., on a same circuit board with the vehicle controller 14 or otherwise a part of the vehicle controller 14) without departing from the scope of the present disclosure.

The automated driving system 36 is used to automatically control various components and/or systems of the vehicle 12 (e.g., steering systems, acceleration systems, braking systems, and/or the like) to automatically drive the vehicle 12, and/or to provide driving assistance features to an occupant or driver of the vehicle 12. In a non-limiting example, the automated driving system 36 utilizes data processed/provided by one or more of the one or more compute modules 18 of the vehicle controller 14 to control one or more electro-mechanical actuators of the vehicle 12, thereby altering a path of the vehicle 12, adjusting a speed of the vehicle 12, and/or the like.

With continued reference to FIG. 1, a remote server system is illustrated and generally indicated by reference number 50. The remote server system 50 includes a server controller 52 in electrical communication with a server database 54 and a server communication system 56. In a non-limiting example, the remote server system 50 is located in a server farm, datacenter, or the like, and connected to the internet.

The server controller 52 includes at least one server processor 58 and a server non-transitory computer readable storage device or server media 60. The description of the type and configuration given above for the vehicle controller 14 also applies to the server controller 52. In some examples, the server controller 52 may differ from the vehicle controller 14 in that the server controller 52 is capable of a higher processing speed, includes more memory, includes more inputs/outputs, and/or the like. In a non-limiting example, the server processor 58 and server media 60 of the server controller 52 are similar in structure and/or function to the processor and the media of the vehicle controller 14, as described above.

The server database 54 is used to store configuration information about the vehicle controller 14 and the DSD 20. In an exemplary embodiment, the server database 54 includes one or more mass storage devices, such as, for example, hard disk drives, magnetic tape drives, magneto-optical disk drives, optical disks, solid-state drives, and/or additional devices operable to store data in a persisting and machine-readable fashion. In some examples, the one or more mass storage devices may be configured to provide redundancy in case of hardware failure and/or data corruption, using, for example, a redundant array of independent disks (RAID). In a non-limiting example, the server controller 52 may execute software such as, for example, a database management system (DBMS), allowing data stored on the one or more mass storage devices to be organized and accessed.

The server communication system 56 is used to communicate with external systems, such as, for example, the vehicle controller 14 via the vehicle communication system 34. In a non-limiting example, the server communication system 56 is similar in structure and/or function to the vehicle communication system 34, as described above. In some examples, the server communication system 56 may differ from the vehicle communication system 34 in that the server communication system 56 is capable of higher power signal transmission, more sensitive signal reception, higher bandwidth transmission, additional transmission/reception protocols, and/or the like.

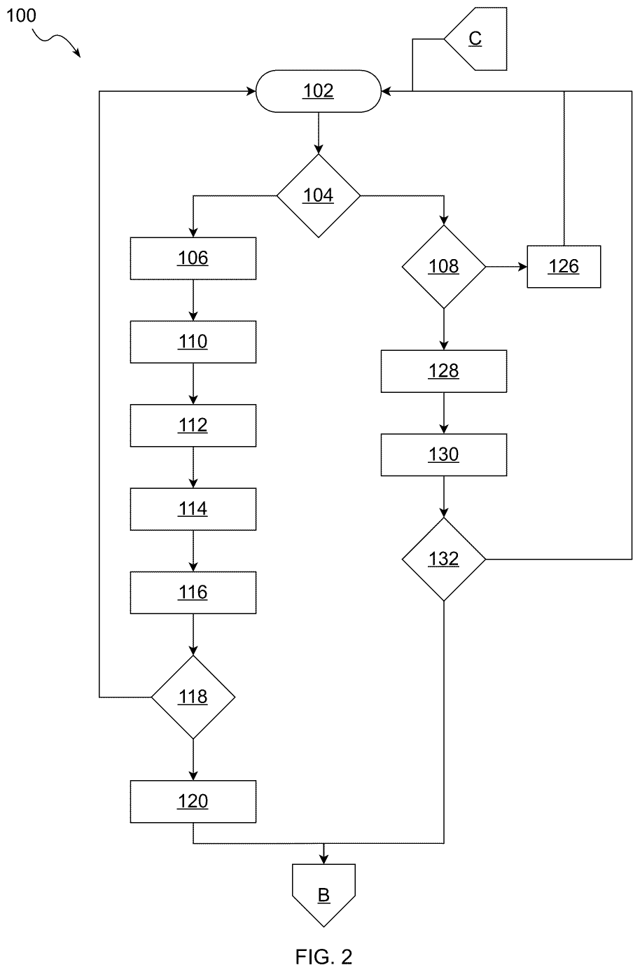

Referring to FIG. 2, a flowchart of the method 100 for configuring or updating an attestation passkey on the DSD 20 is provided. In the scope of the present disclosure, the attestation passkey is a shared symmetric secret between the SMC 22 and the DSD 20. Only the authentic DSD 20 will know the attestation passkey, thus protecting against use of an unauthorized data storage device. Furthermore, the DSD 20 is configured to operate in a lockdown mode (as will be discussed in greater detail below) before authentication with the attestation passkey, preventing unauthorized data access. This security architecture is also referred to as symmetric key attestation. In an exemplary embodiment, it is necessary to configure the attestation passkey (and thus execute the method 100) upon initial manufacturing/integration of the vehicle controller 14, upon replacement of the DSD 20, and/or upon replacement or service of other components of the vehicle controller 14 (e.g., the SMC 22). The method 100 begins at block 102 and proceeds to block 104.

At block 104, the SMC 22 determines an operational mode of the DSD 20. In the scope of the present disclosure, the operational mode indicates whether the DSD 20 is being operated in a factory (e.g., for initial manufacturing, provisioning, and/or configuration of the DSD 20 and/or the vehicle controller 14) or whether the DSD 20 is being operated in an end-user environment (e.g., after production of the vehicle 12). Therefore, the operational mode of the DSD includes one of: a factory mode and a non-factory mode. The factory mode indicates that the DSD 20 is in a factory environment, and thus that data security protocols may be relaxed in the interest of ease of programming and configuration of the DSD 20. The non-factory mode indicates that the DSD 20 is in an end-user environment, including in possession of a dealer, a customer, a service center, and/or the like, and thus that data security protocols should be most stringent. It should be understood that the factory mode is typically only active once during the service life of the vehicle 12 (i.e., during production). In a non-limiting example, to determine the operational mode, the SMC 22 checks the status of an operational mode flag in memory of the DSD controller 26. In another non-limiting example, to determine the operational mode, the SMC 22 checks the status of an operational mode flag in memory of the SMC 22. If the operational mode is the non-factory mode, the method 100 proceeds to block 106. If the operational mode is the factory mode, the method 100 proceeds to block 108.

At block 106, the SMC 22 retrieves a unique identification number of the DSD 20 and a nonce from the DSD 20 in response to determining that the operational mode of the DSD 20 is the non-factory mode. In the scope of the present disclosure, the unique identification number is a unique number uniquely identifying the DSD 20. In the scope of the present disclosure, a nonce is an arbitrary number used only once in a cryptographic communication. In a non-limiting example, the unique identification number is stored in the NVM of the DSD controller 26. In a non-limiting example, the nonce is generated by the DSD controller 26 using a cryptographically secure pseudorandom number generator (CSPRNG) algorithm. The SMC 22 then transmits the unique identification number and the nonce to the remote server system 50 using the vehicle communication system 34. After block 106, the method 100 proceeds to block 110.

At block 110, the remote server system 50 generates a unique new attestation passkey. In an exemplary embodiment, the new attestation passkey is a random number. In a non-limiting example, the server controller 52 uses a cryptographically secure pseudorandom number generator (CSPRNG) algorithm to generate the new attestation passkey. In an exemplary embodiment, the new attestation passkey is stored (e.g., in an encrypted form) in the server database 54 with the corresponding unique identification number of the DSD 20. After block 110, the method 100 proceeds to block 112.

At block 112, the remote server system 50 encrypts the new attestation passkey. In an exemplary embodiment, the server controller 52 first calculates a key encryption key (KEK) based at least in part on a shared secret key shared between the remote server system 50 and the DSD 20, the nonce from the DSD 20, and the unique identification number of the DSD 20. In an exemplary embodiment, the shared secret key is programmed in the NVM of the DSD 20 during manufacturing of the DSD 20 based on a pre-generated list of unique device identification numbers and corresponding shared secret keys generated by the remote server system 50 and transmitted to the manufacturer of the DSD 20. In a non-limiting example, the KEK is calculated using a key-based hash (e.g., an AES-based CMAC algorithm). The server controller 52 then generates an encrypted new attestation passkey by using the KEK to encrypt the new attestation passkey using an encryption algorithm (e.g., an advanced encryption standard (AES) algorithm). After block 112, the method 100 proceeds to block 114.

At block 114, the remote server system 50 transmits the encrypted new attestation passkey to the DSD 20. In an exemplary embodiment, the server controller 52 first calculates an attestation passkey transport message authentication code (MAC) key based at least in part on the shared secret key shared between the remote server system 50 and the DSD 20 and the nonce from the DSD 20. In a non-limiting example, the attestation passkey transport MAC key is calculated using a key-based hash (e.g., an AES-based CMAC algorithm). In a non-limiting example, the attestation passkey transport MAC key is calculated based at least in part on the unique identification number of the DSD 20. The server controller 52 then generates an attestation passkey transport MAC based at least in part on the attestation passkey transport MAC key and the encrypted attestation passkey using a MAC algorithm (e.g., using a keyed cryptographic hash function such as a CMAC algorithm). The server controller 52 then uses the server communication system 56 to transmit the encrypted attestation passkey and the attestation passkey transport MAC to the SMC 22 via the vehicle communication system 34. The SMC 22 then transmits the encrypted attestation passkey and the attestation passkey transport MAC to the DSD 20. After block 114, the method 100 proceeds to block 116.

At block 116, the DSD controller 26 independently calculates the attestation passkey transport MAC key based at least in part on the shared secret key shared between the remote server system 50 and the DSD 20 and the nonce from the DSD 20. After block 116, the method 100 proceeds to block 118.

At block 118, the DSD controller 26 uses the independently calculated attestation passkey transport MAC key to verify the integrity and the authenticity of the encrypted new attestation passkey received at block 114 based on the attestation passkey transport MAC received at block 114. In a non-limiting example, the DSD controller 26 uses the same MAC algorithm utilized by the server controller 52 at block 114 to calculate an expected attestation passkey transport MAC based on the independently calculated attestation passkey transport MAC key and the encrypted new attestation passkey received at block 114. The expected attestation passkey transport MAC is then compared to the attestation passkey transport MAC received from the SMC 22 at block 114. If the expected attestation passkey transport MAC matches the attestation passkey transport MAC received at block 114, the encrypted new attestation passkey received at block 114 is considered to be intact, and the method 100 proceeds to block 120. Otherwise, the encrypted new attestation passkey received at block 114 is considered to be corrupted or tampered with, and the method 100 is restarted at block 102.

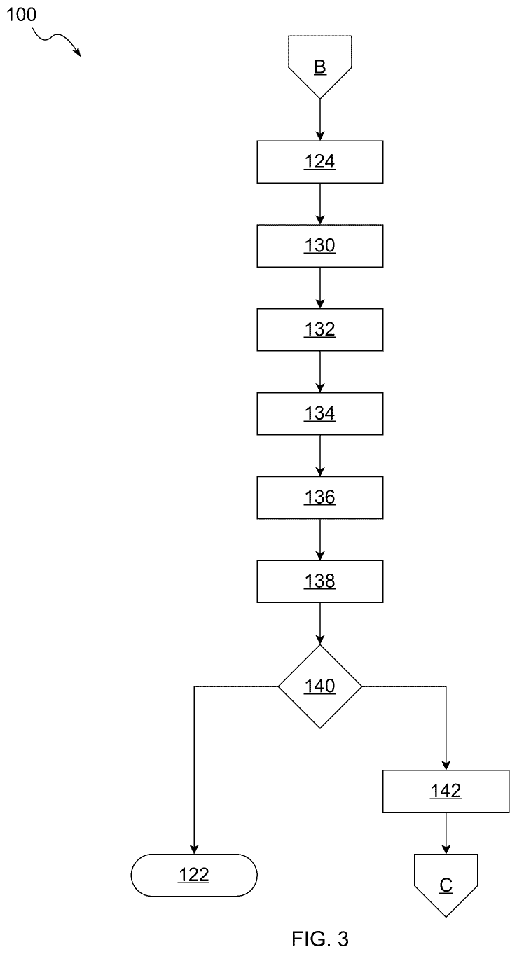

At block 120, the DSD controller 26 decrypts the encrypted new attestation passkey. In an exemplary embodiment, the DSD controller 26 first calculates the KEK based at least in part on the shared secret key shared between the remote server system 50 and the DSD 20 and the nonce from the DSD 20. The DSD controller 26 then uses the KEK to decrypt the encrypted new attestation passkey received at block 114. After block 120, the method 100 proceeds to block 124 (FIG. 3, via off-page reference B), as will be discussed in greater detail below.

At block 108, the SMC 22 checks a manufacturing enablement code (MEC) stored in the non-transitory media of the SMC 22. In the scope of the present disclosure, the MEC is a counter which is initialized at a predetermined value (e.g., fifty) upon manufacturing the vehicle controller 14 and decremented upon every boot of the vehicle controller 14. Furthermore, the MEC is ideally manually set to zero upon completion of production of the vehicle 12. If the MEC is equal to zero, factory mode should be disabled and the method 100 proceeds to block 126. If the MEC is greater than zero, the method 100 proceeds to block 128.

At block 126, the SMC 22 disables factory mode. In an exemplary embodiment, the SMC 22 sets the MEC to zero and performs a factory reset (i.e., data and configuration erasure) of the DSD 20. After block 126, the method 100 returns to block 102.

At block 128, the SMC 22 generates the new attestation passkey in response to determining that the operational mode of the DSD 20 is the factory mode. In an exemplary embodiment, the new attestation passkey is a random number. In a non-limiting example, the SMC 22 uses a cryptographically secure pseudorandom number generator (CSPRNG) algorithm to generate the new attestation passkey. After block 128, the method 100 proceeds to block 130.

At block 130, the SMC 22 transmits the new attestation passkey generated at block 128 in plaintext to the DSD 20. In an exemplary embodiment, the new attestation passkey is transmitted with the attestation passkey transport MAC for integrity verification. In a non-limiting example, the new attestation passkey is input in plaintext into a cryptographic block cipher algorithm (e.g., an AES algorithm) along with a known block cipher key. The cryptographic block cipher algorithm is applied to the attestation passkey, generating the attestation passkey transport MAC. The attestation passkey transport MAC serves as a cryptographic representation of the new attestation passkey, ensuring that any unauthorized modification to or corruption of the new attestation passkey during transmission will be detectable. The new attestation passkey and the attestation passkey transport MAC are then transmitted to the DSD controller 26. After block 130, the method 100 proceeds to block 132.

At block 132, the DSD controller 26 of the DSD 20 receives the new attestation passkey and the attestation passkey transport MAC transmitted at block 130. The DSD controller 26 then verifies the integrity of the new attestation passkey in plaintext using the attestation passkey transport MAC. In an exemplary embodiment, the DSD controller 26 uses the cryptographic block cipher algorithm to calculate an expected attestation passkey transport MAC based on the known block cipher key and the new attestation passkey in plaintext received at block 132. If the attestation passkey transport MAC received at block 132 does not match the expected attestation passkey transport MAC, the method 100 is restarted at block 102. If the attestation passkey transport MAC received at block 130 matches the expected attestation passkey transport MAC, the method 100 proceeds to block 124 (FIG. 3, via off-page reference B), as will be discussed in greater detail below.

Referring to FIG. 3, a continuation of the flowchart of FIG. 2 of the method 100 for configuring the attestation passkey on the DSD 20 is provided. At block 124, the DSD controller 26 writes the new attestation passkey to the NVM of the DSD controller 26. In an exemplary embodiment, the new attestation passkey is also stored in the non-transitory media of the SMC 22 (e.g., in an encrypted form). After block 124, the method 100 proceeds to block 130. At block 130, the DSD controller 26 derives an NVM programming MAC key which will be used to ensure that the new attestation passkey was correctly written to the NVM. In an exemplary embodiment, the NVM programming MAC key is determined based at least in part on the new attestation passkey stored in the NVM and a programming nonce generated by the DSD controller 26. In a non-limiting example, the NVM programming MAC key is also calculated based at least in part on the unique identification number of the DSD 20. In a non-limiting example, the NVM programming MAC key is calculated using an independent key-based hash (e.g., AES-MP (Miyaguchi-Preneel)). In a non-limiting example, the NVM programming MAC key is determined using a different key-based hash from the key-based hash used to generate the attestation passkey transport MAC key at block 114. After block 130, the method 100 proceeds to block 132.

At block 132, the DSD controller 26 calculates an NVM programming MAC of a known test vector. In an exemplary embodiment, the DSD controller 26 uses the NVM programming MAC key derived at block 130 to calculate the NVM programming MAC of the known test vector. In a non-limiting example, the known test vector is a vector of zeros or ones. After block 132, the method 100 proceeds to block 134.

At block 134, the DSD controller 26 transmits the NVM programming MAC of the known test vector calculated at block 132 and the programming nonce generated at block 130 to the SMC 22. After block 134, the method 100 proceeds to block 136. At block 136, the SMC 22 calculates an SMC programming MAC key based on the programming nonce received at block 134 and the new attestation passkey stored in the SMC 22. In a non-limiting example, the SMC programming MAC key is calculated using the same key-based hash as used to calculate the NVM programming MAC key at block 130 (e.g., an AES-based CMAC algorithm). After block 136, the method 100 proceeds to block 138. At block 138, the SMC 22 calculates an SMC programming MAC of the known test vector. In an exemplary embodiment, the SMC 22 uses the SMC programming MAC key derived at block 136 to calculate the SMC programming MAC of the same known test vector used at block 132. After block 138, the method 100 proceeds to block 140.

At block 140, the SMC 22 compares the NVM programming MAC received at block 134 to the SMC programming MAC calculated at block 138. If the NVM programming MAC does not match the SMC programming MAC, the new attestation passkey stored in the NVM is considered to be tampered with and/or corrupt, and the method 100 proceeds to block 142. At block 142, the SMC 22 commands the DSD controller 26 to erase the new attestation passkey from NVM of the DSD controller 26, and the method 100 is restarted at block 102 (FIG. 2, via off-page reference C). If the NVM programming MAC does match the SMC programming MAC, the new attestation passkey stored in the NVM is considered to be correct, and the method 100 proceeds to enter the standby state at block 122 and is concluded. In an exemplary embodiment, the SMC 22 saves a flag in memory indicating successful completion of the method 100.

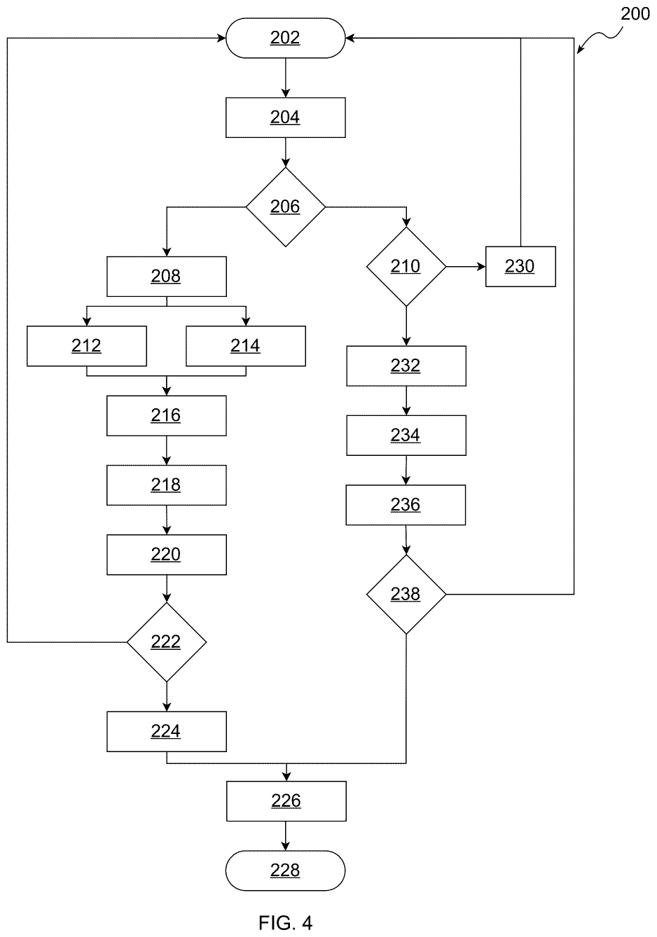

Referring to FIG. 4, a flowchart of the method 200 for configuring or updating a credential pin (C_PIN) on the DSD 20 is shown. In the scope of the present disclosure, the C_PIN is used for access control on the DSD 20 according to, for example, the Opal Storage Specification published by the Trusted Computing Group. For example, the C_PIN is used to authenticate users (e.g., devices in the system 10) when sending commands to the DSD 20. In an exemplary embodiment, it may be necessary to configure the C_PIN (and thus execute the method 200) upon initial manufacturing/integration of the vehicle controller 14, upon replacement of the DSD 20, and/or upon replacement or service of other components of the vehicle controller 14 (e.g., the SMC 22). Furthermore, the C_PIN may be configured at any time. The method 200 begins at block 202 and proceeds to block 204. At block 204, the SMC 22 generates a new C_PIN. In an exemplary embodiment, the SMC 22 uses a cryptographically secure pseudorandom number generator (CSPRNG) algorithm to generate the new C_PIN. After block 204, the method 200 proceeds to block 206.

At block 206, the SMC 22 determines an operational mode of the DSD 20. In the scope of the present disclosure, the operational mode indicates whether the DSD 20 is being operated in a factory (e.g., for initial manufacturing, provisioning, and/or configuration of the DSD 20 and/or the vehicle controller 14) or whether the DSD 20 is being operated in an end-user environment (e.g., after production of the vehicle 12). Therefore, the operational mode of the DSD includes one of: a factory mode and a non-factory mode. The factory mode indicates that the DSD 20 is in a factory environment, and thus that data security protocols may be relaxed in the interest of ease of programming and configuration of the DSD 20. The non-factory mode indicates that the DSD 20 is in an end-user environment, including in possession of a dealer, a customer, a service center, and/or the like, and thus that data security protocols should be most stringent. It should be understood that the factory mode is typically only active once during the service life of the vehicle 12 (i.e., during production). In a non-limiting example, to determine the operational mode, the SMC 22 checks the status of an operational mode flag in memory of the DSD controller 26. In another non-limiting example, to determine the operational mode, the SMC 22 checks the status of an operational mode flag in memory of the SMC 22. If the operational mode is the non-factory mode, the method 200 proceeds to block 208. If the operational mode is the factory mode, the method 200 proceeds to block 210.

At block 208, the SMC 22 retrieves a C_PIN nonce from the DSD 20 in response to determining that the operational mode is the non-factory mode. In a non-limiting example, the C_PIN nonce is generated by the DSD controller 26 using a cryptographically secure pseudorandom number generator (CSPRNG) algorithm. After block 208, the method 200 proceeds to blocks 212 and 214.

At block 212, the SMC 22 generates a C_PIN key encryption key (KEK). In an exemplary embodiment, the C_PIN KEK is generated based at least in part on the C_PIN nonce from the DSD 20 received at block 208, the attestation passkey stored in the non-transitory media of the SMC 22, and the unique identification number of the DSD 20. In a non-limiting example, the C_PIN KEK is calculated using a key-based hash (e.g., an AES-based CMAC algorithm). After block 212, the method 200 proceeds to block 216. At block 214, the SMC 22 generates a C_PIN transport message authentication code (MAC) key. In an exemplary embodiment, the C_PIN transport MAC key is generated based at least in part on the C_PIN nonce from the DSD 20 received at block 208 and the attestation passkey stored in the non-transitory media of the SMC 22. In a non-limiting example, the C_PIN transport MAC key is calculated using a key-based hash (e.g., an AES-based CMAC algorithm). After block 214, the method 200 proceeds to block 216. At block 216, the SMC 22 encrypts the new C_PIN generated at block 204. In an exemplary embodiment, the SMC 22 generates an encrypted new C_PIN by using the C_PIN KEK generated at block 212 to encrypt the new C_PIN using an encryption algorithm (e.g., an advanced encryption standard (AES) algorithm). After block 216, the method 200 proceeds to block 218.

At block 218, the SMC 22 generates a C_PIN transport MAC. In an exemplary embodiment, the SMC 22 generates the C_PIN transport MAC based at least in part on the C_PIN transport MAC key generated at block 214 and the encrypted new C_PIN generated at block 216 using a MAC algorithm (e.g., using a keyed cryptographic hash function such as a CMAC algorithm). After block 218, the method 200 proceeds to block 220. At block 220, the SMC 22 transmits the encrypted new C_PIN with the C_PIN transport MAC to the DSD 20. After block 220, the method 200 proceeds to block 222.

At block 222, the DSD controller 26 of the DSD 20 verifies the integrity of the encrypted new C_PIN received at block 220. In an exemplary embodiment, the DSD controller 26 first independently calculates the C_PIN transport MAC key based at least in part on the C_PIN nonce generated at block 208. The DSD controller 26 then uses the same MAC algorithm utilized by the SMC 22 at block 218 to calculate an expected C_PIN transport MAC based on the independently calculated C_PIN transport MAC key and the encrypted new C_PIN received at block 220. The expected C_PIN transport MAC is then compared to the C_PIN transport MAC received from the SMC 22 at block 220. If the expected C_PIN transport MAC matches the C_PIN transport MAC received at block 220, the encrypted new C_PIN received at block 220 is considered to be intact, and the method 200 proceeds to block 224. Otherwise, the encrypted new C_PIN received at block 220 is considered to be corrupted or tampered with, and the method 200 restarts at block 202.

At block 224, the DSD controller 26 decrypts the encrypted new C_PIN. In an exemplary embodiment, the DSD controller 26 first independently calculates the C_PIN KEK based at least in part on the C_PIN nonce generated at block 208. The DSD controller 26 then uses the C_PIN KEK to decrypt the encrypted C_PIN received at block 220. After block 224, the method 200 proceeds to block 226, as will be discussed below.

At block 210, the SMC 22 checks a manufacturing enablement code (MEC) stored in the non-transitory media of the SMC 22. In the scope of the present disclosure, the MEC is a counter which is initialized at a predetermined value (e.g., fifty) upon manufacturing the vehicle controller 14 and decremented upon every boot of the vehicle controller 14. Furthermore, the MEC is ideally manually set to zero upon completion of production of the vehicle 12. If the MEC is equal to zero, factory mode should be disabled and the method 200 proceeds to block 230. If the MEC is greater than zero, the method 200 proceeds to block 232.

At block 230, the SMC 22 disables factory mode. In an exemplary embodiment, the SMC 22 sets the MEC to zero and performs a factory reset (i.e., data and configuration erasure) of the DSD 20. After block 230, the method 200 returns to block 202.

At block 232, the SMC 22 generates the C_PIN transport message authentication code (MAC) key in response to determining that the operational mode is the factory mode. In an exemplary embodiment, the C_PIN transport MAC key is generated using a well-known block cipher key. In the scope of the present disclosure, a well-known block cipher key refers to a fixed, predetermined key associated with a standardized or publicly defined algorithm, like an advanced encryption standard (AES) algorithm. In a non-limiting example, the C_PIN transport MAC key is calculated using a key-based hash (e.g., an AES-based CMAC algorithm). After block 232, the method 200 proceeds to block 234.

At block 234, the SMC 22 generates the C_PIN transport MAC. In an exemplary embodiment, the SMC 22 generates the C_PIN transport MAC based at least in part on the C_PIN transport MAC key generated at block 232 and the new C_PIN generated at block 204 using a MAC algorithm (e.g., using a keyed cryptographic hash function such as a CMAC algorithm). After block 234, the method 200 proceeds to block 236. At block 236, the SMC 22 transmits the new C_PIN in plaintext with the C_PIN transport MAC to the DSD 20. After block 236, the method 200 proceeds to block 238.

At block 238, the DSD controller 26 of the DSD 20 verifies the integrity of the new C_PIN received at block 236. In an exemplary embodiment, the DSD controller 26 first independently calculates the C_PIN transport MAC key based at least in part on the same well-known block cipher key. The DSD controller 26 then uses the same MAC algorithm utilized by the SMC 22 at block 234 to calculate an expected C_PIN transport MAC based on the independently calculated C_PIN transport MAC key and the new C_PIN received at block 236. The expected C_PIN transport MAC is then compared to the C_PIN transport MAC received from the SMC 22 at block 236. If the expected C_PIN transport MAC matches the C_PIN transport MAC received at block 236, the new C_PIN received at block 236 is considered to be intact, and the method 200 proceeds to block 226, as will be discussed below. Otherwise, the new C_PIN received at block 236 is considered to be corrupted or tampered with, and the method 200 restarts at block 202.

At block 226, the DSD controller 26 securely stores the new C_PIN. In a non-limiting example, the new C_PIN is stored in plaintext in a protected section of memory (e.g., in the NVM of the DSD controller 26). In another non-limiting example, the new C_PIN is stored in an encrypted form in memory (e.g., in the NVM of the DSD controller 26). After block 226, the method 200 proceeds to enter a standby state at block 228.

In an exemplary embodiment, after provisioning of both the attestation passkey and the C_PIN, the DSD 20 is switched into the non-factory mode.

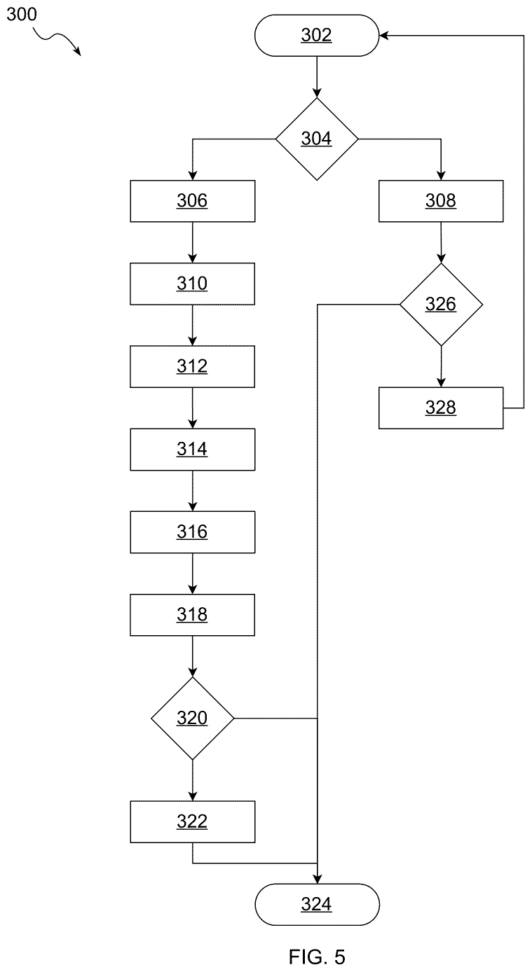

Referring to FIG. 5, a flowchart of the method 300 for operating the system 10 is shown. In an exemplary embodiment, the method 300 is executed upon every boot (i.e., startup/power-on) of the vehicle controller 14. The method 300 begins at block 302 and proceeds to block 304.

At block 304, the SMC 22 determines an operational mode of the DSD 20. In the scope of the present disclosure, the operational mode indicates whether the DSD 20 is being operated in a factory (e.g., for initial manufacturing, provisioning, and/or configuration of the DSD 20 and/or the vehicle controller 14) or whether the DSD 20 is being operated in an end-user environment (e.g., after production of the vehicle 32). Therefore, the operational mode of the DSD includes one of: a factory mode and a non-factory mode. The factory mode indicates that the DSD 20 is in a factory environment, and thus that data security protocols may be relaxed in the interest of ease of programming and configuration of the DSD 20. The non-factory mode indicates that the DSD 20 is in an end-user environment, including in possession of a dealer, a customer, a service center, and/or the like, and thus that data security protocols should be most stringent. It should be understood that the factory mode is typically only active once during the service life of the vehicle 12 (i.e., during production). In a non-limiting example, to determine the operational mode, the SMC 22 checks the status of an operational mode flag in memory of the DSD controller 26. In another non-limiting example, to determine the operational mode, the SMC 22 checks the status of an operational mode flag in memory of the SMC 22. If the operational mode is the non-factory mode, the method 300 proceeds to block 306. If the operational mode is the factory mode, the method 300 proceeds to block 308.

At block 306, the DSD 20 boots in the lockdown mode in response to determining that the operational mode is the non-factory mode. In the scope of the present disclosure, the lockdown mode is an operational mode of the DSD controller 26 wherein the DSD controller 26 is configured to ignore all commands received by the DSD from the SMC 22 besides a predetermined list of allowed commands. Furthermore, in the lockdown mode, the DSD controller 26 is initially configured to restrict all of the one or more ports 30. In the scope of the present disclosure, the DSD controller 26 is configured not to send any data or commands via restricted ports and ignore all data or commands received via restricted ports besides the predetermined list of allowed commands. One or more of the one or more ports 30 may be unrestricted within the lockdown mode, as will be discussed below. After block 306, the method 300 proceeds to block 310.

At block 310, the SMC 22 generates a random challenge. In the scope of the present disclosure, the random challenge is a large random number (e.g., a 256-bit random number). In a non-limiting example, the SMC 22 generates the random challenge using a cryptographically secure pseudorandom number generator (CSPRNG) algorithm. In another non-limiting example, the SMC 22 generates the random challenge using a monotonic counter. It should be understood that the random challenge may be any unique input which is not repeated. After block 310, the method 300 proceeds to block 312.

At block 312, the SMC 22 calculates a correct challenge response to the random challenge generated at block 310. In an exemplary embodiment, the correct challenge response is determined by calculating a MAC of the random challenge with a predetermined algorithm (e.g., a CMAC algorithm, an HMAC algorithm, a GMAC algorithm, and/or the like) using the attestation passkey stored in the non-transitory media of the SMC 22. The result of encrypting the random challenge using the attestation passkey is the correct challenge response. The SMC 22 stores the correct challenge response in the non-transitory memory. After block 312, the method 300 proceeds to block 314.

At block 314, the SMC 22 transmits the random challenge to the DSD controller 26. In an exemplary embodiment, the SMC 22 uses at least one of the allowed commands to transmit the random challenge to the DSD controller 26. After block 314, the method 300 proceeds to block 316. At block 316, the DSD controller 26 calculates a challenge response using the same predetermined algorithm used at block 312 and the attestation passkey stored in the NVM of the DSD controller 26. After block 316, the method 300 proceeds to block 318.

At block 318, the SMC 22 reads the challenge response generated by the DSD controller 26 at block 316 from the DSD controller 26 using at least one of the allowed commands. After block 318, the method 300 proceeds to block 320. At block 320, the SMC 22 compares the challenge response read at block 318 to the correct challenge response generated at block 312. If the challenge response read at block 318 matches the correct challenge response generated at block 312, the DSD 20 is considered to be authenticated and the method 300 proceeds to block 322. If the challenge response read at block 318 does not match the correct challenge response generated at block 312, the DSD 20 is considered to be unauthenticated, and the method 300 proceeds to enter a standby state at block 324.

At block 322, the SMC 22 unrestricts one or more of the one or more ports 30 of the DSD 20 in response to authenticating the DSD 20 at block 320. In the scope of the present disclosure, unrestricted ports are activated, and the DSD controller 26 may send and/or receive data using unrestricted ports and utilize all commands and features. In an exemplary embodiment, the SMC 22 uses at least one of the allowed commands to command the DSD controller 26 to unrestrict one or more of the one or more ports 30. In a non-limiting example, the command to unrestrict one or more of the one or more ports 30 is authenticated using a lockdown key derived from the attestation passkey.

In a non-limiting example, the SMC 22 unrestricts all ports connected to any of the one or more compute modules 18. In another non-limiting example, the SMC 22 unrestricts a subset of the one or more ports 30. In an exemplary embodiment, the subset of the one or more ports 30 is determined based on authentication and/or verification of each device connected to each of the one or more ports 30 (e.g., the one or more compute modules 18). In an exemplary embodiment, at block 322, the SMC 22 also commands the DSD 20 to unlock the DSD 20 using the C_PIN stored in the NVM of the DSD 20. In the scope of the present disclosure, unlocking the DSD 20 includes enabling an in-line encryption/decryption engine to allow encrypted data stored on the DSD 20 to be read and decrypted. After block 322, the method 300 proceeds to enter the standby state at block 324.

At block 308, the DSD 20 boots in an non-lockdown mode in response to determining that the operational mode is the factory mode. In the scope of the present disclosure, the non-lockdown mode is an operational mode of the DSD controller 26 wherein the DSD controller 26 is configured to honor most/all commands received by the DSD 20 from the SMC 22. Furthermore, in the non-lockdown mode, the DSD controller 26 is configured to unrestrict all of the one or more ports 30. After block 308, the method 300 proceeds to block 326.

At block 326, the SMC 22 checks a manufacturing enablement code (MEC) stored in the non-transitory media of the SMC 22. In the scope of the present disclosure, the MEC is a counter which is initialized at a predetermined value (e.g., fifty) upon manufacturing the vehicle controller 14 and decremented upon every boot of the vehicle controller 14. Furthermore, the MEC is ideally manually set to zero upon completion of production of the vehicle 12. If the MEC is equal to zero, factory mode should be disabled and the method 300 proceeds to block 328. If the MEC is greater than zero, the method 300 proceeds to enter the standby state at block 324.

At block 328, the SMC 22 disables factory mode. In an exemplary embodiment, the SMC 22 sets the MEC to zero and performs a factory reset (i.e., data and configuration erasure) of the DSD 20. After block 328, the method 300 returns to block 302.

In an exemplary embodiment, the method 300 may exit the standby state 324 a predetermined number of times (e.g., five times) and restart the method 300 at block 302 to attempt to authenticate the DSD 20. In another exemplary embodiment, the method 300 may periodically exit the standby state 324 at predetermined and/or random intervals to re-authenticate the DSD 20.

The system 10 and methods 100, 200, and 300 of the present disclosure offer several advantages. Firstly, the system 10 and methods 100, 200, and 300 utilize symmetric keys which are unique for each device, reducing the impact of a compromised key. Using the system 10 and method 300, the functionality of the DSD 20 is controlled based on operational mode (e.g., factory mode or non-factory mode) of the DSD 20 to provide ease of programming, provisioning, and configuration in the factory environment while providing robust security in the non-factory environment. For example, using the method 300, malicious actors are unable to extract data from the DSD 20 by removing the DSD 20 from the vehicle controller 14. Furthermore, malicious actors are unable to influence the operation of the vehicle controller 14 by installing a malicious data storage device in the vehicle controller 14. Using the system 10 and the methods 100 and 200, the DSD 20 can be securely configured for both attestation and self-encrypting functionality in both the factory and the non-factory environments.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for provisioning a data storage device (DSD) using a security management controller (SMC), the method comprising:
determining an operational mode of the DSD, wherein the operational mode includes one of: a factory mode and a non-factory mode;
configuring an attestation passkey on the DSD based at least in part on the operational mode of the DSD, wherein the attestation passkey is used to unlock communication between the DSD and one or more external devices; and
configuring a credential pin (C_PIN) on the DSD based at least in part on the operational mode of the DSD, wherein the C_PIN is used for access control on the DSD.

2. The method of claim 1, wherein configuring the attestation passkey further comprises:
generating a new attestation passkey based at least in part on the operational mode of the DSD;
transmitting the new attestation passkey to the DSD based at least in part on the operational mode of the DSD;
writing the new attestation passkey to a non-volatile memory (NVM) of the DSD; and
verifying an integrity of the new attestation passkey stored in the NVM.

3. The method of claim 2, wherein generating the new attestation passkey further comprises:
generating the new attestation passkey using a remote server system in response to determining that the operational mode is the non-factory mode; and
generating the new attestation passkey using the SMC in response to determining that the operational mode is the factory mode.

4. The method of claim 2, wherein transmitting the new attestation passkey to the DSD further comprises:
generating an encrypted new attestation passkey by encrypting the new attestation passkey with a key encryption key (KEK) using a remote server system in response to determining that the operational mode is the non-factory mode, wherein the KEK is generated based at least in part on a nonce generated by the DSD;
transmitting the encrypted new attestation passkey to the DSD with an attestation passkey transport message authentication code (MAC) for integrity verification in response to determining that the operational mode is the non-factory mode; and
transmitting the new attestation passkey in plaintext to the DSD with the attestation passkey transport MAC for integrity verification in response to determining that the operational mode is the factory mode.

5. The method of claim 4, wherein writing the new attestation passkey to the NVM further comprises:
verifying an integrity of the new attestation passkey in plaintext or the encrypted new attestation passkey using the attestation passkey transport MAC; and
writing the new attestation passkey to the NVM in response to determine that the new attestation passkey in plaintext or the encrypted new attestation passkey is intact.

6. The method of claim 2, wherein verifying the integrity of the new attestation passkey stored in the NVM further comprises:
deriving a NVM programming message authentication code (MAC) key using the DSD based at least in part on the new attestation passkey stored in the NVM and a programming nonce;
calculating an NVM programming MAC of a known test vector using the DSD;
transmitting the NVM programming MAC and the programming nonce to the SMC;
calculating an SMC programming MAC key based on the programming nonce and the new attestation passkey;
calculating an SMC programming MAC of the known test vector using the SMC; and
verifying the integrity of the new attestation passkey stored in the NVM by comparing the SMC programming MAC to the NVM programming MAC.

7. The method of claim 1, wherein configuring the C_PIN further comprises:
generating a new C_PIN;
transmitting the new C_PIN to the DSD based at least in part on the operational mode of the DSD;
storing the new C_PIN in the DSD; and
verifying an integrity of the new C_PIN stored in the DSD.

8. The method of claim 7, wherein transmitting the new C_PIN to the DSD further comprises:
transmitting an encrypted new C_PIN to the DSD with a C_PIN transport MAC for integrity verification in response to determining that the operational mode is the non-factory mode; and
transmitting the new C_PIN in plaintext to the DSD with a C_PIN transport MAC for integrity verification in response to determining that the operational mode is the factory mode.

9. The method of claim 8, wherein transmitting the new C_PIN to the DSD further comprises:
retrieving a C_PIN nonce from the DSD;
generating a C_PIN key encryption key (KEK) using the SMC based on the C_PIN nonce in response to determining that the operational mode is the non-factory mode;
generating a C_PIN transport message authentication code (MAC) key using the SMC based on the C_PIN nonce;
generating an encrypted new C_PIN by encrypting the new C_PIN with the C_PIN KEK in response to determining that the operational mode is the non-factory mode;
generating a C_PIN transport MAC using the C_PIN transport MAC key;
transmitting the encrypted new C_PIN to the DSD with the C_PIN transport MAC for integrity verification in response to determining that the operational mode is the non-factory mode; and
transmitting the new C_PIN in plaintext to the DSD with the C_PIN transport MAC for integrity verification in response to determining that the operational mode is the factory mode.

10. The method of claim 9, wherein storing the new C_PIN in the DSD further comprises:
verifying an integrity of the new C_PIN in plaintext or the encrypted new C_PIN received from the SMC using the C_PIN transport MAC;
calculating the C_PIN KEK using the DSD in response to determining that the operational mode is the non-factory mode;
determining the new C_PIN in plaintext by decrypting the encrypted new C_PIN using the C_PIN KEK in response to determining that the operational mode is the non-factory mode; and
securely storing the new C_PIN in the DSD.

11. A system for secure data storage, the system comprising:
a security management controller (SMC);
a data storage device (DSD) in electrical communication with the SMC, wherein the DSD includes a DSD controller and one or more ports for electrical communication with external devices, and wherein the DSD controller is programmed to:
determine an operational mode of the DSD, wherein the operational mode includes one of: a factory mode and a non-factory mode;
start the DSD in a lockdown mode in response to determining that the operational mode is the non-factory mode, wherein, in the lockdown mode, the DSD is configured to ignore all commands received by the DSD besides a predetermined list of allowed commands, and wherein, in the lockdown mode, the DSD is further configured to restrict the one or more ports; and
start the DSD in an non-lockdown mode in response to determining that the operational mode is the factory mode; and
wherein the SMC is programmed to:
authenticate the DSD in response to determining that the operational mode is the non-factory mode; and
unrestrict one or more of the one or more ports in response to authenticating the DSD.

12. The system of claim 11, wherein to authenticate the DSD, the SMC is further programmed to:
generate a random challenge;
calculate a correct challenge response to the random challenge based at least in part on the random challenge and an attestation passkey;
transmit the random challenge to the DSD controller using at least one of the allowed commands;
read a challenge response from the DSD controller using at least one of the allowed commands; and
authenticate the DSD in response to determining that the challenge response matches the correct challenge response.

13. The system of claim 12, wherein the SMC is further programmed to update the attestation passkey on the DSD, and wherein to update the attestation passkey on the DSD, the SMC is further programmed to:
generate a new attestation passkey based at least in part on the operational mode of the DSD;
transmit the new attestation passkey to the DSD controller based at least in part on the operational mode of the DSD;
write the new attestation passkey to a non-volatile memory (NVM) of the DSD; and
verify an integrity of the new attestation passkey stored in the NVM.

14. The system of claim 13, wherein to generate the new attestation passkey, the SMC is further programmed to:
retrieve the new attestation passkey from a remote server system in response to determining that the operational mode is the non-factory mode, wherein the new attestation passkey is generated by the remote server system based at least in part on a unique identification number of the DSD and a nonce generated by the data storage device; and
generate the new attestation passkey using the SMC in response to determining that the operational mode is the factory mode.

15. The system of claim 14, wherein to transmit the new attestation passkey to the DSD, the SMC is further programmed to:
generate an encrypted new attestation passkey by encrypting the new attestation passkey with a key encryption key (KEK) using the remote server system in response to determining that the operational mode is the non-factory mode;
transmit the encrypted new attestation passkey to the DSD with an attestation passkey transport message authentication code (MAC) for integrity verification in response to determining that the operational mode is the non-factory mode; and
transmit the new attestation passkey in plaintext to the DSD with the attestation passkey transport MAC for integrity verification in response to determining that the operational mode is the factory mode.

16. The system of claim 15, wherein to verify the integrity of the new attestation passkey stored in the NVM, the SMC is further programmed to:
receive an NVM programming message authentication code (MAC) and a programming nonce from the DSD, wherein the NVM programming MAC is calculated by the DSD controller based at least in part on the new attestation passkey stored in the NVM and the programming nonce;
calculate an SMC programming MAC based at least in part on based on the programming nonce and the new attestation passkey; and
verify the integrity of the new attestation passkey stored in the NVM by comparing the SMC programming MAC to the NVM programming MAC.

17. The system of claim 12, wherein the SMC is further programmed to update a credential pin (C_PIN) on the DSD, and wherein to update the C_PIN on the DSD, the SMC is further programmed to:
generate a new C_PIN;
transmit an encrypted new C_PIN to the DSD with a C_PIN transport MAC for integrity verification in response to determining that the operational mode is the non-factory mode;
transmit the new C_PIN in plaintext to the DSD with a C_PIN transport MAC for integrity verification in response to determining that the operational mode is the factory mode;
store the new C_PIN in the DSD; and
verify an integrity of the new C_PIN stored in the DSD.

18. A system for secure data storage for a vehicle controller, the system comprising:
a vehicle controller including:
a solid-state drive (SSD), wherein the SSD includes a flash memory controller and one or more ports for electrical communication with external devices; and
a security management controller (SMC) in electrical communication with the SSD, wherein the SMC is programmed to:
determine an operational mode of the SSD, wherein the operational mode includes one of: a factory mode and a non-factory mode;
authenticate the SSD using an attestation passkey in response to determining that the operational mode is the non-factory mode; and
unrestrict one or more of the one or more ports in response to authenticating the SSD.

19. The system of claim 18, wherein the SMC is further programmed to update the attestation passkey on the SSD, and wherein to update the attestation passkey on the SSD, the SMC is further programmed to:
generate a new attestation passkey based at least in part on the operational mode of the SSD;
transmit the new attestation passkey to the flash memory controller based at least in part on the operational mode of the SSD, wherein the new attestation passkey is encrypted before transmission in response to determining that the operational mode is the non-factory mode;
write the new attestation passkey to a non-volatile memory (NVM) of the SSD; and
verify an integrity of the new attestation passkey stored in the NVM.

20. The system of claim 19, wherein the SMC is further programmed to update a credential pin (C_PIN) on the SSD, wherein the C_PIN is used for access control on the SSD, and wherein to update the C_PIN on the SSD, the SMC is further programmed to:
generate a new C_PIN;
transmit an encrypted new C_PIN to the SSD with a C_PIN transport MAC for integrity verification in response to determining that the operational mode is the non-factory mode;
transmit the new C_PIN in plaintext to the SSD with a C_PIN transport MAC for integrity verification in response to determining that the operational mode is the factory mode;
store the new C_PIN in the SSD; and
verify an integrity of the new C_PIN stored in the SSD.
